(19) United States
(12) Patent Application Publication
(10) Pub. No.: US 2016/0291510 A1
(43) Pub. Date: Oct. 6, 2016

(54) IMAGE FORMING APPARATUS

(71) Applicant: CANON KABUSHIKI KAISHA, Tokyo (JP)

(72) Inventor: Kenichi Shibuya, Toride-shi (JP)

(21) Appl. No.: 15/185,672

(22) Filed: Jun. 17, 2016

Related U.S. Application Data
(63) Continuation of application No. PCT/JP2014/084771, filed on Dec. 19, 2014.

(30) Foreign Application Priority Data
Dec. 20, 2013 (JP) 2013-263296
Dec. 18, 2014 (JP) 2014-256720

(51) Int. Cl. G03G 15/16

(52) U.S. Cl. CPC G03G 15/1665

(57) ABSTRACT

In an image forming apparatus including a plurality of image forming stations, a pre-exposure device is at least not provided in a most upstream image forming apparatus at which a toner image formed by the image forming station cannot arrive, and the pre-exposure device is at least provided in a most downstream image forming apparatus at which the toner image formed by the image forming station can arrive.

### TECHNICAL FIELD

The present invention relates to an image forming apparatus. As this image forming apparatus, for example, it is possible to cite image forming apparatuses such as a copying machine, a printer, a facsimile (FAX) machine, and a multi-function machine having a plurality of functions of these machines.

### BACKGROUND ART

In recent years, a so-called tandem type image forming apparatus including a plurality (four) of image forming stations has been proposed. Such an image forming apparatus is capable of quickly forming a color image using an electrophotographic process, and therefore, receives attention.

In each image forming station, around a photosensitive member, a charging device (charging means), an exposure device (exposure means) and developing device (developing means) are provided. Further, toner images formed at the respective image forming stations are successively transferred superposedly onto an intermediary transfer member (image receiving member), and thereafter, are transferred onto a recording material altogether.

Here, as a type of the charging device, two types, i.e., an “AC charging type” for (electrically) charging the photosensitive member by applying a superposed voltage of an AC voltage and a DC voltage and a “DC charging type” for (electrically) charging the photosensitive member by applying only the DC voltage have been known.

The “AC charging type” is advantageous in that a surface of the photosensitive member can be uniformly charged compared with the “DC charging type”, but a discharge amount to the photosensitive member is large and therefore the photosensitive member tends to be liable to deteriorate. Further, an expensive AC voltage (power) source is needed. On the other hand, compared with the “AC charging type”, in the “DC charging type”, the photosensitive member does not readily deteriorate, but tends to be inferior in charging uniformity. That is, compared with the “DC charging type”, the “AC charging type” is high in initial costs and running costs. In other words, compared with the “AC charging type”, the “DC charging type” is advantageous in terms of the running costs and the initial costs.

Therefore, in the case where the “DC charging type” is intended to be employed, the following problems can generate.

Specifically, in an apparatus described in Japanese Laid-Open Patent Application 2002-189400, in order to lower a potential (residual potential) of the photosensitive member remaining after transfer to the neighborhood of 0 V, a device for optically discharging the photosensitive member, a so-called a pre-exposure device (discharging means) is mounted. Thus, in the case where a method of discharging the photosensitive member by using the pre-exposure device is employed, in the charging device, the photosensitive member has to be charged from the neighborhood of 0 V to a desired potential (e.g., −700 V), and compared with the case where a discharging step by the pre-exposure device is not performed, a discharge current becomes large. That is, compared with the case where the discharging step by the pre-exposure device is not performed, the photosensitive member tends to be liable to deteriorate.

On the other hand, in the case where the discharging step is not performed without providing the pre-exposure device (there is an advantage of cost reduction), the photosensitive member only has a discharging effect by a transfer device. This discharging effects depends on a toner image formed in a preceding image forming station, i.e., an amount of a toner which is a resistor, and in the case where this amount is large, the step goes to a subsequent charging step while the photosensitive member little has the discharging effect. Particularly, when each of toner images formed in first and second image forming stations has a maximum density (two color solid images), in transfer steps of third and fourth image forming stations, the photosensitive members little have the discharging effect. Resulting from this, there is a liability that a ghost image (defective image) generates on a subsequent image. That is, in the third and fourth stations, from their arrangement viewpoint, a density of a coming toner image tends to become high, so that there is a liability that the ghost image can generate.

On the other hand, in the first image forming station, from its arrangement viewpoint, there is no coming toner image, and therefore there is no liability that the ghost image generates.

### SUMMARY OF THE INVENTION

An object of the present invention is to provide an image forming apparatus capable of suppressing generation of image defect while reducing Costs.

Another object will become apparent by reading the following detailed description while making reference to the attached drawings.

A first invention is an image forming apparatus comprising: a first image forming station including a first photosensitive member, charging means configured to charge the first photosensitive member, first exposure means configured to expose the first photosensitive member charged by the first charging means to light on the basis of first image data, and a first developing means configured to develop with a toner an electrostatic latent image formed on the first photosensitive member by the first exposure means; a second image forming station including a second photosensitive member, second charging means configured to charge the second photosensitive member by being supplied with only a DC voltage, second exposure means configured to expose the second photosensitive member charged by the second charging means to light on the basis of second image data, and a second developing means configured to develop with a toner an electrostatic latent image formed on the second photosensitive member by the second exposure means; and transfer means configured to electrostatically transfer superposedly a toner image formed on the first photosensitive member and a toner image formed on the second photosensitive member onto an image receiving member in this order, wherein the first image forming station is not provided with discharging means configured to optically discharge the first photosensitive member, and the second image forming station is provided with discharging means configured to optically discharge the second photosensitive member.

A second invention is an image forming apparatus comprising: a first image forming station including a first photosensitive member, first charging means configured to charge the first photosensitive member, first exposure means configured to expose the first photosensitive member charged by the first charging means to light on the basis of first image data, and a first developing means configured to develop with a toner an electrostatic latent image formed on the first photosensitive member by the first exposure means; a second image forming station including a second photosensitive member, second charging means configured to charge the second photosensitive member, second exposure means configured to expose the second photosensitive member charged by the second charging means to light on the basis of second image data, and a second developing means configured to develop with a toner an electrostatic latent image formed on the second photosensitive member by the second exposure means; a third image forming station including a third photosensitive member, third charging means configured to charge the third photosensitive member by being supplied with only a DC voltage, third exposure means configured to expose the third photosensitive member charged by the third charging means to light on the basis of third image data, and a third developing means configured to develop with a toner an electrostatic latent image formed on the third photosensitive member by the third exposure means; a fourth image forming station including a fourth photosensitive member, fourth charging means configured to charge the fourth photosensitive member by being supplied with only a DC voltage, fourth exposure means configured to expose the fourth photosensitive member charged by the fourth charging means to light on the basis of fourth image data, and a fourth developing means configured to develop with a toner an electrostatic latent image formed on the fourth photosensitive member by the fourth exposure means; and transfer means configured to electrostatically transfer superposedly a toner image formed on the first photosensitive member, a toner image formed on the second photosensitive member, a toner image formed on the second photosensitive member, and a toner image formed on the fourth photosensitive member onto an image receiving member in this order, wherein the first image forming station and the second image forming station are not provided with discharging means, respectively, configured to optically discharge corresponding ones of the photosensitive members, and the third image forming station and the fourth image forming station are provided with discharging means, respectively, configured to optically discharge corresponding ones of the photosensitive members.

A third invention is an image forming apparatus comprising: a first image forming station including a first photosensitive member, first charging means configured to charge the first photosensitive member, first exposure means configured to expose the first photosensitive member charged by the first charging means to light on the basis of first image data, and a first developing means configured to develop with a toner an electrostatic latent image formed on the first photosensitive member by the first exposure means; a second image forming station including a second photosensitive member, second charging means configured to charge the second photosensitive member by being supplied with only a DC voltage, second exposure means configured to expose the second photosensitive member charged by the second charging means to light on the basis of second image data, and a second developing means configured to develop with a toner an electrostatic latent image formed on the second photosensitive member by the second exposure means; a third image forming station including a third photosensitive member, third charging means configured to charge the third photosensitive member by being supplied with only a DC voltage, third exposure means configured to expose the third photosensitive member charged by the third charging means to light on the basis of third image data, and a third developing means configured to develop with a toner an electrostatic latent image formed on the third photosensitive member by the third exposure means; a fourth image forming station including a fourth photosensitive member, fourth charging means configured to charge the fourth photosensitive member by being supplied with only a DC voltage, fourth exposure means configured to expose the fourth photosensitive member charged by the fourth charging means to light on the basis of fourth image data, and a fourth developing means configured to develop with a toner an electrostatic latent image formed on the fourth photosensitive member by the fourth exposure means; and transfer means configured to electrostatically transfer superposedly a toner image formed on the first photosensitive member, a toner image formed on the second photosensitive member, a toner image formed on the second photosensitive member, and a toner image formed on the fourth photosensitive member onto an image receiving member in this order, wherein the first image forming station is not provided with discharging means, respectively, configured to optically discharge corresponding ones of the photosensitive members, and the second image forming station the third image forming station and the fourth image forming station are provided with discharging means, respectively, configured to optically discharge corresponding ones of the photosensitive member.

### BRIEF DESCRIPTION OF THE DRAWINGS

FIG. 1 is a schematic illustration of an image forming apparatus in which a pre-exposure device is not provided in all of image forming stations.

FIG. 2 is a view for illustrating a layer structure of a charging roller and a layer structure of a photosensitive drum of an image forming apparatus according to an embodiment.

FIG. 3 is an operation sequence diagram of the image forming apparatus according to the embodiment.

FIG. 4 is a schematic illustration of the image forming apparatus according to the embodiment.

FIG. 5 is a schematic illustration of an image forming apparatus according to an embodiment.

FIG. 6 is a block diagram of the image forming apparatus according to the embodiment.

FIG. 7 is a flowchart for illustrating an operation of the image forming apparatus according to the embodiment.

FIG. 8 is a graph showing a relationship of execution and non-execution of pre-exposure with an applied charging bias and a charge potential on a photosensitive drum in an image forming apparatus according to an embodiment.

FIG. 9 is a flowchart for illustrating an operation of the image forming apparatus according to the embodiment.

In FIG. 10, (a) is a view showing an image example of a transfer ghost, and (b) is a view for illustrating a generation mechanism of the transfer ghost.

FIG. 11 is a schematic illustration of an image forming apparatus according to another embodiment.

### EMBODIMENTS FOR CARRYING OUT THE INVENTION

In the following, embodiments according to the present invention will be described based on the attached drawings.

### Embodiment 1

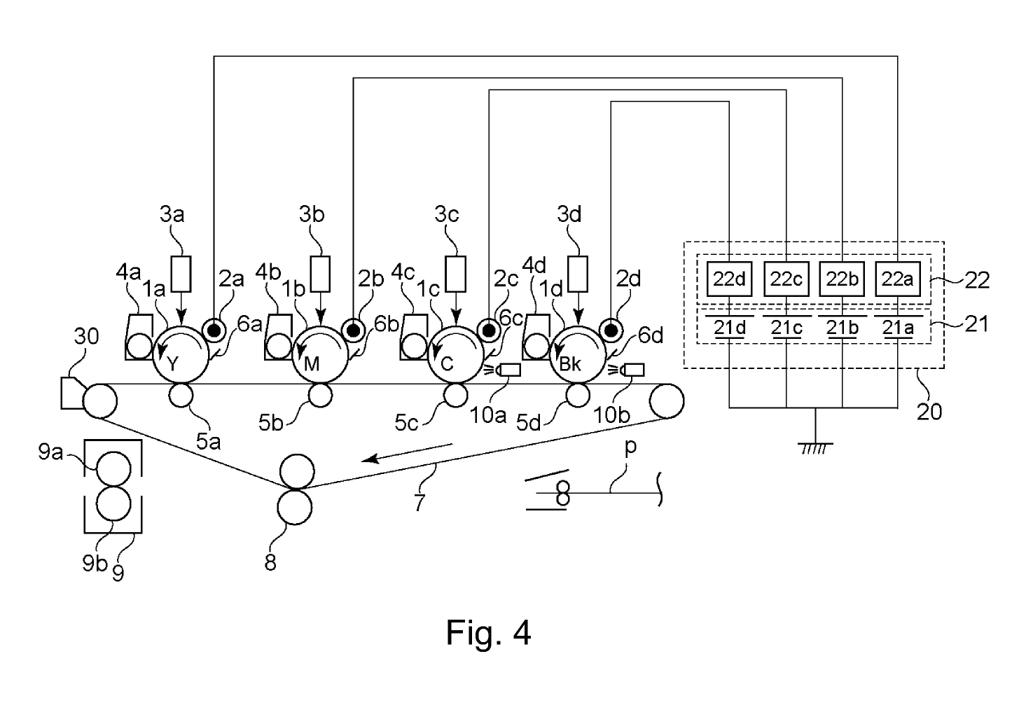

FIG. 4 is a schematic illustration showing an image forming apparatus according to the present invention. Incidentally, as the image forming apparatus, the present invention is applicable to image forming apparatuses such as copying machine, a printer, a FAX machine, and a multi-function machine having a plurality of functions of these machines, and in this embodiment, a full-color printer will be described as an example. First, details of image forming stations mounted in the image forming apparatus will be described.

### (Image Forming Station)

The image forming apparatus includes a plurality (four) of image forming stations, and these four image forming stations are arranged with certain intervals along a movement direction of an intermediary transfer belt 7. The four image forming stations are image forming stations Y, M, C and Bk for colors of yellow (first), magenta (second), cyan (third) and black (fourth), respectively. Further, in the following, in the case where the colors are abbreviated as Y, M, C and Bk, these colors mean yellow, magenta, cyan and black, respectively.

In upstream image forming stations (first image forming stations) Y and M, photosensitive members (hereinafter also referred to as photosensitive drums) 1a and 1b are provided, respectively. Further, at peripheries of the respective photosensitive drums 1a and 1b, charging rollers 2a and 2b which are charging devices (charging means), exposure devices (exposure means) 3a and 3b, developing devices (developing means) 4a and 4b, and cleaning devices (cleaning means) 6a and 6b are provided.

In downstream image forming stations (second image forming stations) C and Bk, photosensitive members 1c and 1d are provided, respectively. Further, at peripheries of the respective photosensitive drums 1c and 1d, charging rollers 2c and 2d which are charging devices (charging means), exposure devices (exposure means) 3c and 3d, developing devices (developing means) 4c and 4d, and cleaning devices (cleaning means) 6c and 6d are provided.

### (Photosensitive Member)

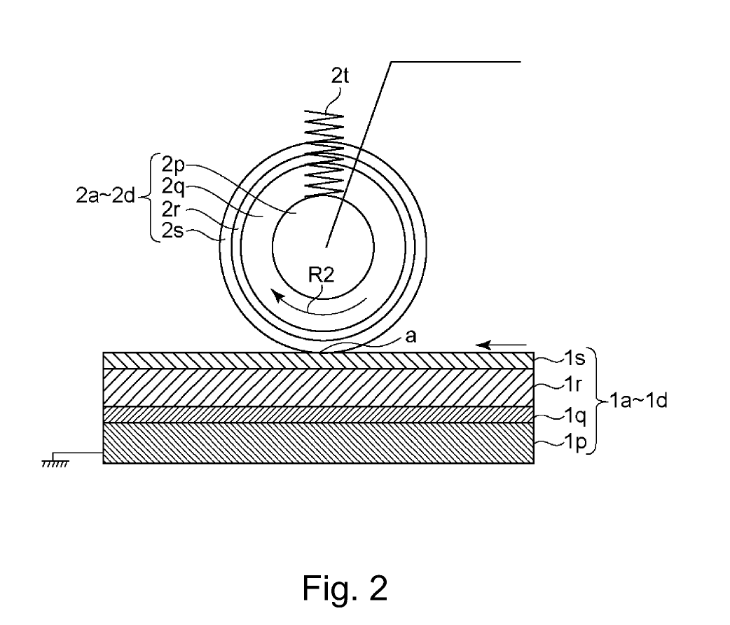

The photosensitive drums 1a-1d are negatively chargeable organic photosensitive members (OPCs) of 30 mm in outer diameter in this embodiment, and are rotationally driven in arrow directions at a process speed of 210 mm/s in general by drive of a driving device (not shown). The photosensitive drums 1a-1d are, as shown in FIG. 2, constituted by applying, onto a surface of an aluminum-made cylinder (electroconductive drum substrate) 1p, 3 layers of an undercoat layer 1q for suppressing light interference and for improving an adhesive property to an upper layer, a photo-charge generation layer 1r and a charge transport layer is in this order from below.

### (Charging Device)

The charging rollers 2a, 2b, 2c and 2d uniformly charge the surfaces of the photosensitive drums 1a, 1b, 1c and 1d by DC voltages applied from an unshown high-voltage circuit (charging bias voltage source). The charging rollers are provided so as to be contactable to the photosensitive drums. In this embodiment, the charging bias was −1300 V, and a potential (Vd; dark-portion potential (potential of a portion which is not subjected to image exposure)) was set so as to be −700 V at a developing position of the developing device by charging the photosensitive drum by electric discharge from the charging roller.

Specifically, the charging rollers 2a-2d charge the surfaces of the photosensitive drums 1a-1d to a predetermined potential by a charging bias (only a DC voltage) applied from the high-voltage circuit (charging bias voltage source) 20. Specifically, to the charging rollers 2a-2d, a DC voltage of a negative polarity identical to the normal output polarity of the toner is applied, so that the surfaces of the photosensitive drums 1a-1d are charged to the negative polarity.

The bias (voltage) is generated by a combination of the high-voltage circuit 20, a DC voltage generating circuit 21 and DC voltage amplifying circuit 22. In FIG. 4, DC voltages applied to the charging rollers 2a-2d of the respective image forming stations are applied by the DC voltage generating circuits 21a, 21b, 21c and 21d in the DC voltage generating circuit 21. Further, magnitudes of DC voltage values thereof are adjusted by the DC voltage amplifying circuits 22a, 22b, 22c and 22d in the DC voltage amplifying circuit 22.

In this embodiment, as already described above, the DC charging type (in which the voltage applied to the charging device is only the DC voltage) which can generate a ghost image instead of suppression of costs was employed. Incidentally, as described above, when the AC charging type (in which the voltage applied to the charging device is the superposed voltage of the DC voltage and the AC voltage) is employed, a photosensitive drum residual potential smoothing effect is large, and therefore, although the ghost image does not readily generate, it constitutes a factor of an increase in cost.

Further, longitudinal lengths (lengths in which the charging rollers contact the photosensitive drums) of the charging rollers 2a-2d are 320 mm, and as shown in FIG. 2, each charging roller 2 has a 3-layer structure in which around a core metal 2p (supporting member), layers including an undercoat layer 2q, an intermediary layer 2r and a surface layer 2s are successively laminated from a lower side. The undercoat layer 2q is a foamed sponge layer for reducing a charging noise, and the surface layer 2s is a protective layer provided for preventing generation of leak even when the photosensitive drum has defects such a pinhole thereon.

Specifically, the specifications of the charging rollers 2a-2d in this embodiment are as follows:

Core metal 2p: round stainless rod of 6 mm in diameter Undercoat layer 2q: foamed EPDM in which carbon black particles were dispersed, and which is 0.5 g/cm³ in specific gravity, 10²-10⁹Ω in volume resistivity, and 3.0 mm in thickness
Intermediary layer 2r: NBR rubber in which carbon black particles were dispersed, and which is 10²-10⁵Ω in volume resistivity, and 700 μm in thickness
Surface layer 2s: fluorine-containing resin in which tin oxide particles and carbon black particles were dispersed, and which is 10⁷-10¹⁰Ω in volume resistivity, 1.5 μm in surface roughness (10 point surface roughness Ra according to JIS), and 10 μm in thickness

The charging rollers 2a-2d are urged toward a center of the photosensitive drums by urging springs 2t, so that the charging rollers are press-contacted to the surfaces of the photosensitive drums with a predetermined urging force at charging nips a, and are rotated by the rotational drive of the photosensitive drums in a direction of R2 in the figure.

In this embodiment, the charging rollers having an entire volume resistivity, of the charging rollers 2a-2d of 1.0×10⁵Ω was employed.

### (Exposure Device)

The exposure devices 3a-3d are laser beam scanners using a semiconductor laser. The exposure devices 3a-3d output laser lights modulated correspondingly to an image signals inputted from a host processing device such as an unshown image reading device. The laser lights scan the charged surfaces of the photosensitive drums 1a-1d, so that electrostatic latent images depending on the inputted image signals are formed on the photosensitive members. In this embodiment, a light portion potential (VL) at a portion where the photosensitive drums 1a-1d are irradiated with the laser lights was −200 V.

### (Developing Device)

In the developing devices (developing means) 4a, 4b, 4c and 4d, yellow, magenta, cyan and black toners, respectively, having a negative polarity as a normal charge polarity are accommodated.

To the developing devices 4a, 4b, 4c and 4d, a superposed developing bias of a DC voltage (Vdc) and with an AC voltage (Vac) is applied. Specifically, in this embodiment, the developing bias is 8 kHz in frequency of the AC voltage, is −550 V in the DC voltage, and is 1800 V in peak-to-peak voltage Vpp of the AC voltage. The charge polarity of the toner is the negative polarity, and therefore, the toner is deposited on the light portion of the photosensitive drums by the developing devices through a reverse development type.

### (Transfer Device)

Further, a at a lower portion of the respective image forming stations (respective photosensitive members), primary transfer rollers (transfer member) 5a, 5b, 5c and 5d which are transfer devices (transfer means) are provided opposed to the photosensitive drums via the intermediary transfer belt 7 which is the image receiving member. These primary transfer rollers 5a-5d have a constitution in which they rotate while pressing the intermediary transfer belt 7 toward the photosensitive members 1a-1d.

### (Image Forming Sequence)

An image forming sequence at the respective image forming stations is performed through an electrophotographic process. Image forming processes in all the image forming stations are substantially the same, and therefore, the image forming process (sequence) of the Y image forming station will be described as a representative.

First, the surface of the photosensitive drum 1a is charged substantially uniformly to the negative potential by the charging roller 2a. At this time, to the charging roller 2a, only a DC voltage is applied. Next, on the basis of Y image data, the exposure device 3a subjects the photosensitive drum 1a to image exposure, so that the electrostatic image is formed on the photosensitive drum 1a. Thereafter, the electrostatic image on the photosensitive drum 1a is developed with the toner by the developing device 4a, so that the toner image is formed on the photosensitive drum 1a.

Thus, the color toner images formed on the photosensitive drums 1a, 1b, 1c and 1d, respectively, are electrostatically transferred in this order superposedly onto the intermediary transfer belt 7 which is the image receiving member (transfer receiving member) by the respective transfer rollers 5a-5d. A voltage (DC voltage) applied to each of the transfer rollers 5a-5d is a voltage of a positive polarity which is an opposite polarity to the normal charge polarity of the toner. That is, the polarity of the voltage applied to each of the transfer rollers 5a-5d is an opposite polarity to the polarity of the voltage applied to each of the charging rollers 2a-2d.

Further, the toner images for the four colors transferred superposedly on the intermediary transfer belt 7 are transferred altogether onto the recording material P, fed by a paper (sheet) feeding mechanism, by a secondary transfer roller 8 which is a transfer mechanism. At this time, to the secondary transfer roller 8, a DC voltage of the positive polarity is applied.

Thereafter, the recording material P separated from the secondary transfer roller 8 is subjected to a fixing process by a fixing device 9. Specifically, in a fixing nip roller 9a and a pressing roller 9b, a full-color toner image is heated and pressed, and is fixed on the recording material P. Thereafter, the recording material P is discharged to an outside of the image forming apparatus. Incidentally, the toner, on the intermediary transfer belt 7, which has not been completely transferred by the secondary transfer roller 8 is removed by a cleaner 30.

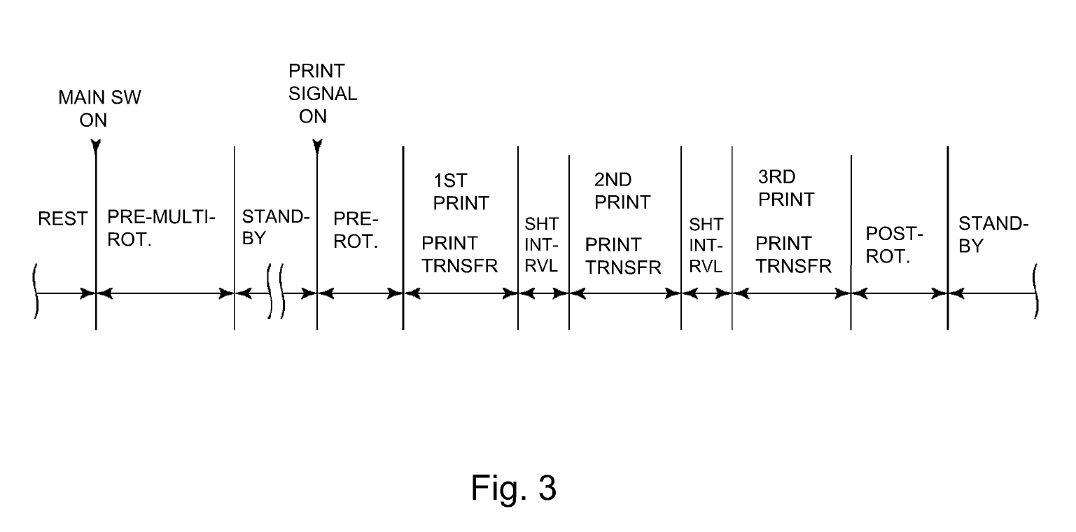

FIG. 3 is a time chart of the image forming sequence.

a. Initial Rotation Operation (Pre-Multi-Rotation Step)

This period is an actuation operation period during actuation of the printer (activation operation period, warming-up period). Preparatory operations (warming-up operations) of predetermined process devices, such as rise of the fixing device 9 to a predetermined temperature by rotationally driving the photosensitive members 1a-1d through turning-on of a main power switch are carried out.

b. Preparatory Rotation Operation for Printing (Pre-Rotation Step)

This period is a preparatory rotation operation period from print signal-ON until an image forming (print) step is actually performed, and when a print signal is inputted during the initial rotation operation, the preparatory rotation operation for printing is carried out subsequently to the initial rotation operation. When no print signal is inputted, drive of a main motor is temporarily stopped after the end of the initial rotation operation, the rotational drive of the photosensitive drum 1 is stopped, and the printer is kept in a stand-by (waiting) state until a print signal is inputted. When the print signal is inputted, the preparatory rotation operation for printing is carried out.

c. Printing Step (Image Forming Step, Imaging Step)

When the predetermined preparatory rotation operation for printing is ended, subsequently, an image forming process to the photosensitive drums 1a-1d is carried out, so that primary transfer of the toner images formed on the photosensitive drums 1a-1d onto the intermediary transfer belt 7, secondary transfer onto the recording material P, and the fixing process are made and the printing step is ended.

In the case of continuous printing (continuous print) mode, the above-described printing step is repeatedly carried out correspondingly to a preset print number n.

d. Sheet Interval Step

This step is a period in which no recording material P is in the secondary transfer position after a trailing edge of a preceding recording material (sheet) passes through the secondary transfer position until a leading edge of a subsequent recording material (sheet) reaches the secondary transfer portion.

e. Post-Rotation Operation

This period is a period in which the drive of the main motor is continued for a while even after the printing step onto the final recording material is ended and the photosensitive drums 1a-1d are rotationally driven, so that a predetermined post-process operation is carried out.

f. Stand-by

When the predetermined post-rotation operation is ended, the drive of the main motor is stopped and the rotational drive of the photosensitive drums 1a-1d is stopped, and the printer is kept in the stand-by state until a next print signal is inputted.

In the case of print of only one sheet, the printer is put through the post-rotation operation after the printing is ended, and is in a stand-by state.

In the stand-by state, when the print signal is inputted, the printer goes to the pre-rotation step.

During the above-described printing process c is during image formation, and the initial rotation operation a, the pre-rotation operation b, the sheet interval d, and the post-rotation operation e are during non-image formation.

### (With Regard to Ghost Phenomenon)

In such a tandem-type image forming apparatus, for example, it is assumed that a red image (called R patch) obtained by superposing Y (yellow) and M (magenta) toners (maximum deposition amount, so-called solid) is formed. Thereafter, in the case where an HT image (half-tone image, also referred to as CHT) in the image forming station for C (cyan) is formed, a phenomenon that the CHT image partly this generates at a position after one full-turn of the photosensitive drum 1c from passing of the R patch through a transfer position (position of the primary transfer roller 5c).

This phenomenon will be described using (b) of FIG. 10 which is a simplified view of FIG. 4. The R patch formed at the Y and M image forming stations of FIG. 4 is conveyed by the intermediary transfer belt 7 and reaches the transfer position between the photosensitive drum 1c and the primary transfer roller of the C image forming station.

The ordinate of a graph at a lower portion of (b) of FIG. 10 shows a surface potential (negative potential) of the photosensitive drum 1c. Then, at a portion where the R patch exists, compared with a portion where there is no R patch, a residual potential of the photosensitive drum 1c after the primary transfer becomes high in a negative side. This is caused by that the toner of the R patch is the resistor as described above. That is, at the portion where the R patch exists, compared with the portion where there is no R patch, a current flowing when the primary transfer bias (positive voltage) is applied becomes small, and thus the above phenomenon is caused by that the residual potential of the photosensitive drum 1c does not completely lowers toward a zero-potential (0 V).

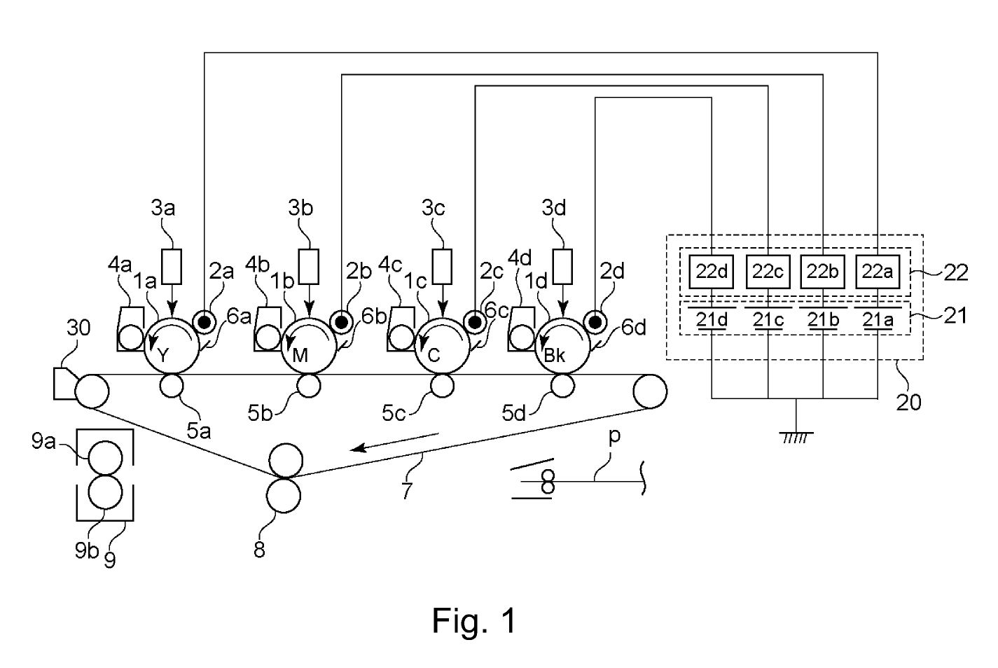

Then, in the case of the image forming apparatus as shown in FIG. 1 in which the pre-exposure device is not provided at all the image forming stations, thereafter even the photosensitive drum 1c is subjected to the charging process by the charging roller 2c, a difference in residual potential slightly remains as a hysteresis thereof. As a result thereof, the residual potential difference is to be capable of being recognized as a ghost on an image subsequently formed on the photosensitive drum 1c. This will be referred to as a ghost phenomenon.

This ghost phenomenon is, as described above, a phenomenon that generates when the toner formed at the upstream image forming station passes through the transfer position of the downstream image forming station. Further, the more the amount of the toner image formed at the upstream image forming station, the more this ghost phenomenon is liable to conspicuously generate. In this embodiment, the toner amount when the R (red) image is formed with the Y toner and the M toner is capable of having the influence on image formation of C and Bk (black). Further, the toner amount when a G (green) image is formed with the Y toner and the C toner or the toner amount when a B (blue) image is formed with the M toner and the C toner is capable of having the influence on image formation of Bk.

Thus, in the case where an image of a secondary color (the case where the toners of two colors are superposed) such as R, G or B comes to the primary transfer position of the downstream image forming station, when the toner amount of the secondary color is large, generation of the ghost phenomenon is conspicuous in the downstream (C, Bk) image forming stations.

Therefore, in this embodiment, as shown in FIG. 4, only at the C and Bk image forming stations (second image forming stations), the pre-exposure device as a discharging means was provided. 10a is the pre-exposure device for irradiating the photosensitive drum 1c with light between the transfer position of the transfer roller 5c and the charging position of the charging roller 2c with respect to a rotational direction of the photosensitive drum 1c. That is, the pre-exposure device 10a performs the function of lowering the potential of the photosensitive drum 1c to the neighborhood of 0 V uniformly by optically discharging the whole surface of the photosensitive drum 1c. Further, 10b is the pre-exposure device for irradiating the photosensitive drum 1d with light between the transfer position of the transfer roller 5d and the charging position of the charging roller 2d with respect to a rotational direction of the photosensitive drum 1d. That is, the pre-exposure device 10d performs the function of lowering the potential of the photosensitive drum 1d to the neighborhood of 0 V uniformly by optically discharging the whole surface of the photosensitive drum 1d.

In this embodiment, the photosensitive drums 10a and 10b employs LEDs arranged in a longitudinal direction of the photosensitive drums 1c and 1d, and were 630 mm in peak wavelength and 130 μW in light quantity.

As the light quantity, a value (μW) measured by using an optical power meter TQ8210 manufactured by Advantest Corp. and by causing a light receiving portion of the power meter to oppose the pre-exposure devices 10a and 10b on the surfaces of the photosensitive drums 1c and 1d which are remotest from the photosensitive drums 10a and 10b was used.

Further, timing of irradiation with pre-exposure light was during the printing step c. and during the sheet interval step d. of FIG. 3. That is, a region of the photosensitive drum which is subjected to the transfer and the charging was irradiated with the pre-exposure light.

By employing the above constitution, a post-transfer potential of the photosensitive drum of the downstream image forming station by the toner image coming from the upstream image forming station is uniformized to the neighborhood of 0 V by the pre-exposure devices 10a and 10b irrespective of the toner amount. Accordingly, in the downstream image forming station, the generation of the ghost phenomenon is suppressed.

Further, in the first and second image forming stations for Y and M, a large potential difference after the transfer and a large potential difference after the charging as in the graph at the lower portion of (b) of FIG. 10 did not generate. Accordingly, in the Y and M image forming stations, pre-exposure devices corresponding to 10a and 10b are not provided.

Incidentally, in the M image forming station, some potential difference after the transfer generates by passing of the toner image formed in the upstream Y image forming station. However, a maximum toner amount of Y (corresponding to one color) is remarkably small compared with the toner amount of the R patch (corresponding to two colors), and therefore the potential difference after the charging as shown in (b) of FIG. 10 does not generate, so that the ghost phenomenon did not generate in the M image forming station.

Accordingly, in this embodiment, the pre-exposure device is not provided in the Y and M image forming stations, and the pre-exposure devices (10a, 10b) are provided in the C and Bk image forming stations. Therefore, while employing the DC charging type capable of enjoying a cost reduction effect, all the image forming stations are not required to be provided with the pre-exposure device, and therefore it is possible to suppress the generation of the ghost phenomenon while reducing the costs.

### Embodiment 2

Next, Embodiment 2 will be described. A basic constitution of an image forming apparatus is the same as that of Embodiment 1, and therefore, will be omitted from detailed description by adding the same reference numerals or symbols.

In Embodiment 2, a point that on/off (actuation/non-actuation) of the pre-exposure devices (10a, 10b) provided in the downstream image forming station (C, Bk) is controlled on the basis of the toner images (toner amounts) formed in the upstream image forming stations (Y, M), i.e., on the basis of image data for Y and image data for M, is largely different.

When the ghost phenomenon is suppressed in the downstream image forming stations (C, Bk), as in Embodiment 1, in the case where the pre-exposure devices 10a and 10b are turned on irrespective of the image data for Y (to which the toner amount of Y corresponds) and the image data for M (to which the toner amount of M corresponds), the turning-on of the pre-exposure devices is disadvantageous in some instances.

This is because subjection to light irradiation from the photosensitive drums 10a and 10b constitutes a factor of deterioration promotion of the photosensitive drums 1c and 1d. That is, the potentials of the photosensitive drums 1c and 1d before the charging step are uniformized to the neighborhood of 0 V by the pre-exposure devices 10a and 10b, and therefore, the potential difference becomes large before and after the charging step. By this potential difference, a discharge current amount by the charging devices 2c and 2d becomes large, so that discharge damage on the photosensitive drums 1c and 1d becomes large. As a result thereof, the photosensitive drums 1c and 1d become worse in dark-decay characteristic (a surface potential lowering speed becomes faster than at an initial stage), and due to this, there is an increasing liability that improper charging generates when the DC charging is made by the charging devices 2c and 2d. Further, the photosensitive drums 1c and 1d are liable to abrade at rubbing (sliding) portions such as cleaning devices (blades) 6c and 6d.

Specifically, in the case of the constitution of Embodiment 1, the photosensitive drums 1c and 1d of the C and Bk image forming stations had an abrasion amount (decreased in film thickness of a photosensitive layer) which was 1.5 times that of the photosensitive drums 1a and 1b of the Y and M image forming stations.

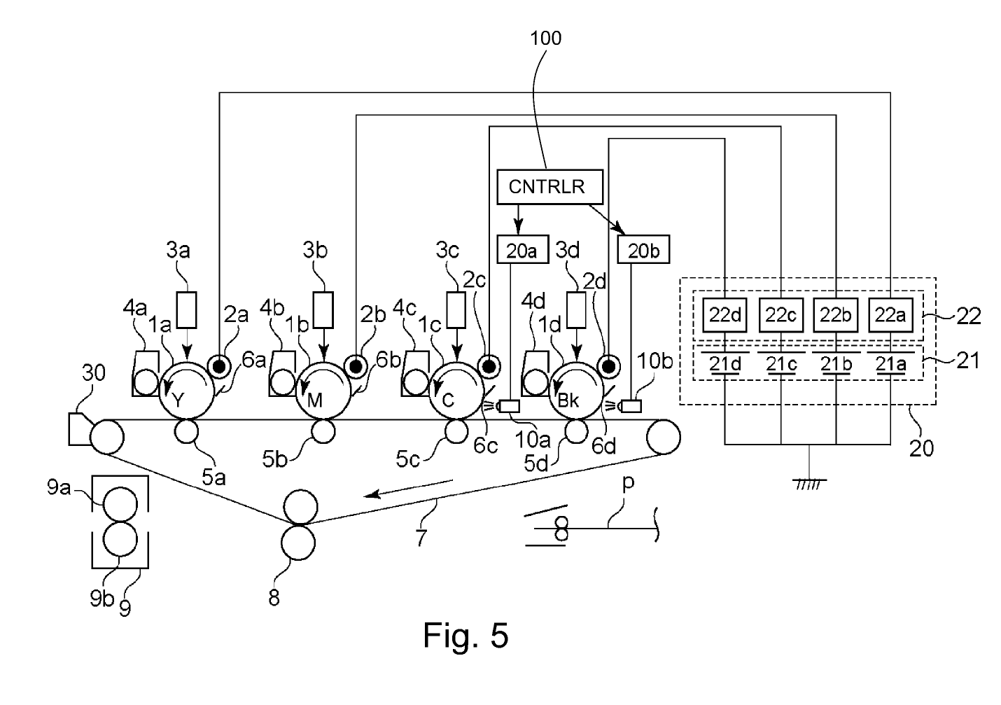

Therefore, in this embodiment, as shown in FIG. 5, pre-exposure controlling devices (functioning as a part of control means) 20a and 20b for controlling operations (on/off) of the pre-exposure devices 10a and 10b are provided. That is, in Embodiment 1, the pre-exposure devices were always turned on in a region subjected to the transfer and the charging, but in Embodiment 2, the pre-exposure devices 10a and 10b were turned off depending on a condition.

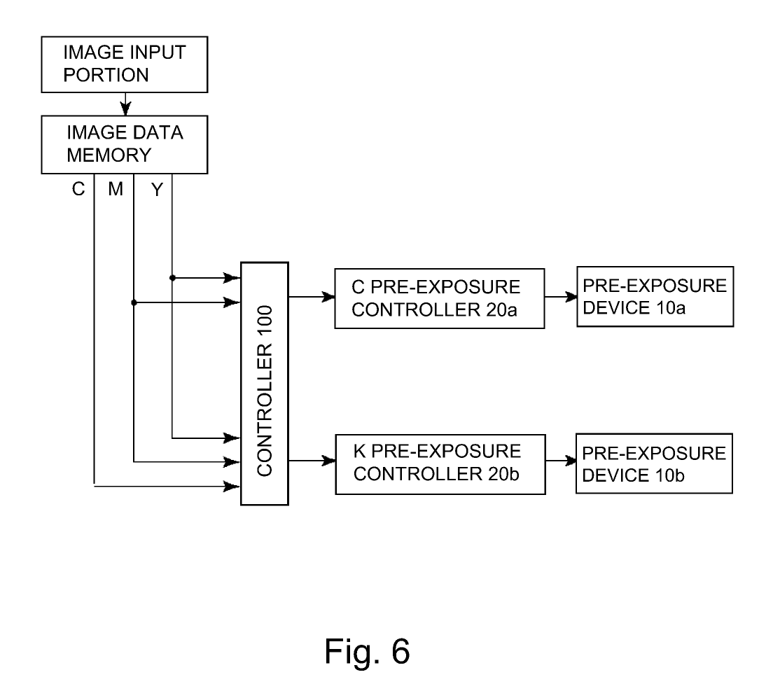

FIG. 6 shows a block diagram in this embodiment. Image data sent from a host computer (e.g., a PC) communication-connected with the image forming apparatus (printer) via a network cable are inputted into an image input portion and then are stored in an image data memory. Then, of the image data stored in the image data memory, the image data of Y, M and C are transmitted to a controller (control means) 100.

Incidentally, in the case where the image forming apparatus has a copying function, image data of an original read by a mounted original reading device are inputted into the image input portion, and subsequent steps are the same as those in the case of the above-described printer.

Then, on the basis of whether the sum of the toner amount of Y corresponding to the Y image data of the image data and the toner amount of M corresponding to the M image data of the image data is not less than a predetermined amount or less than the predetermined amount, the on/on of the pre-exposure devices 10a and 10b is controlled. Specifically, whether or not a maximum value of the sum of image signals which are image information of an overlapping portion of the image data of Y and M is not less than a predetermined value A is discriminated by the controller (CPU) 100. Incidentally, the overlapping portion of the image data corresponds to an overlapping region of the Y toner and the M toner on the intermediary transfer belt 7 (recording material P).

In this embodiment, the image data were obtained by measuring a reflection density of a solid image (maximum density image) formed on the recording material P by a spectral densitometer (503 manufactured by X-Rite Inc.) (in which a reflection density of 1.4 corresponding to the toner of one color is taken as the maximum density), and if the image signal is in a range of 0-255, the image signal 255 was set so as to be the reflection density of 1.4.

Further, in this embodiment, the predetermined amount A was the case where the image signal at the overlapping portion of the Y image signal and the M image signal was 450 (maximum image signal (maximum toner deposition amount) of Y and M was 510).

Further, a flow in which whether or not a maximum value of the sum of image signals which are image information at an overlapping portion of the image data of Y, M and C in not less than a predetermined value B is discriminated by the controller 100 is used in combination.

In this embodiment, the predetermined value B was the case where an image signal at an overlapping portion of the image signals Y, M and C was 450 (maximum (maximum toner deposition amount) of the sun of Y, M and C was 510). Thus, in consideration of fixing process power in the fixing device 9, a maximum total toner deposition amount in the case where Y and M overlap with each other and a total maximum toner deposition amount in the case where Y, M and C overlap with each other are set at the same value.

### (Control Sequence of Photosensitive Drum)

In this embodiment, in the case where not less than the predetermined values A and B is discriminated by the controller 100, the information is transmitted to the pre-exposure controlling devices 20a and 20b, and the pre-exposure controlling devices 20a and 20b provide operation instructions for turning on the photosensitive drums 10a and 10b, respectively.

That is, in the case where in a certain downstream image forming station (e.g., the Bk image forming station), the amount of the toner passing through the transfer position thereof on the intermediary transfer belt 7 is large (in the case where the maximum value of the sum of the image signals is not less than the predetermined value), the ghost phenomenon is liable to generate, and therefore, the pre-exposure devices are turned on.

On the other hand, in the case where in the certain image forming station (e.g., the Bk image forming station), the amount of the toner passing through the transfer position thereof on the intermediary transfer belt 7 is small (in the case where the maximum value of the sum of the image signals is less than the predetermined value), the ghost phenomenon does not readily generate, and therefore, the pre-exposure devices are turned off.

Thus, whether the pre-exposure devices are turned on or off is discriminated by the controller 100 depending on the amount of the toner conveyed to the associated transfer position by the intermediary transfer belt 7.

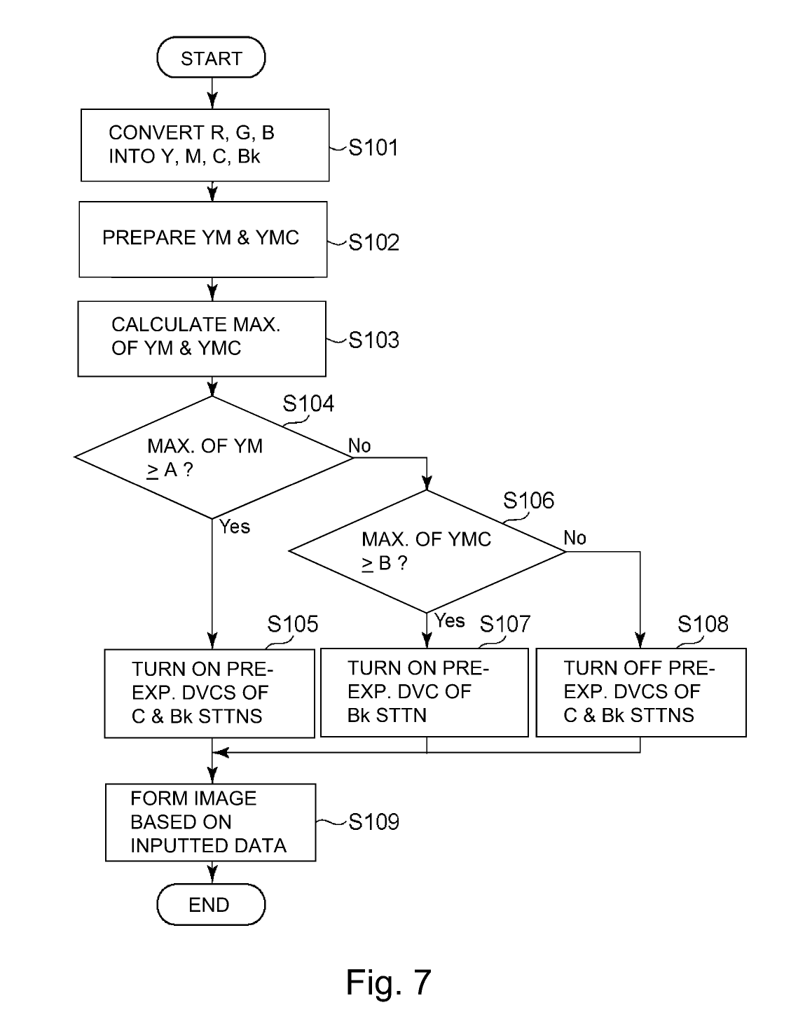

FIG. 7 shows an operation flow.

In the image forming apparatus of FIG. 5, when image formation is started, inputted image data (image data of R, G and B) are converted into image data of Y, M, C and Bk in an image data converting portion in the controller 100 (S101). Of the converted image data, image data YM obtained by synthesizing the Y and M image data and image data YMC obtained by synthesizing the Y, M and C image data are prepared by the controller 100 (S102).

Next, amount values of the image data YM and the image data YMC are calculated by the controller 100 (S103).

Next, whether the maximum value of the image data YM is not less than the predetermined value A is discriminated by the controller 100 (S104). Thus, the discrimination is made using the image data in the two image forming stations (Y, M) in the upstream side.

When the maximum amount is not less than the predetermined amount A, the pre-exposure devices 20a and 20b of the C and Bk image forming stations positioned downstream of the Y and M image forming stations are turned on (S105).

In S104, when the maximum amount is less than the predetermined amount A, whether or not the maximum amount of the image data YMC is not less than the predetermined value B is discriminated by the controller 100 (S106). Thus, the discrimination is made using the image data in the image forming stations (Y, M, C) other than the most downstream Bk image forming station.

When the maximum amount is not less than the predetermined amount B, the pre-exposure device 20b of the Bk image forming station positioned downstream of Y, M and C image forming stations is turned on (S107).

In S106, when the maximum amount is less than the predetermined amount B, the pre-exposure device of the C and Bk image forming stations are still turned off even at desired timing (S108). Next, after the on/off discriminations of the pre-exposure devices in S105, S107 and S108, on the basis of the inputted image data, the respective color images are formed at the respective image forming stations (S109).

Incidentally, a light irradiation condition by the pre-exposure device was, similarly as in Embodiment 1, 630 nm in peak wavelength and 130 μW in light quantity. Further, the turning-on timing of the pre-exposure device was periods of the printing step c. and the sheet interval step d. in FIG. 3.

As described above, control in which the photosensitive drum of the downstream image forming station is turned on only in the case where the toner in a predetermined amount or more comes from the upstream image forming station and in other cases, the light irradiation by the pre-exposure device is not effected is made. As a result, it is possible to not only suppress the generation of the ghost phenomenon in the downstream image forming station but also prolong a lifetime of the photosensitive member of the downstream image forming station.

### Embodiment 3

Next, Embodiment 3 will be described. A basic constitution of an image forming apparatus is the same as those of Embodiments 1 and 2, and therefore, will be omitted from detailed description by adding the same reference numerals or symbols.

In Embodiment 3, compared with the control constitution of Embodiment 2, a point that a charging bias (negative DC voltage) applied to the charging rollers 2c and 2d is switched between the case where the pre-exposure devices (10a, 10b) provided in the downstream image forming stations (C, Bk) are turned on and the case where the pre-exposure devices are turned off, is largely different.

This is because the density of the image formed in the downstream image forming station changes between the case of turning-off of the pre-exposure device and the case of turning-on of the pre-exposure device.

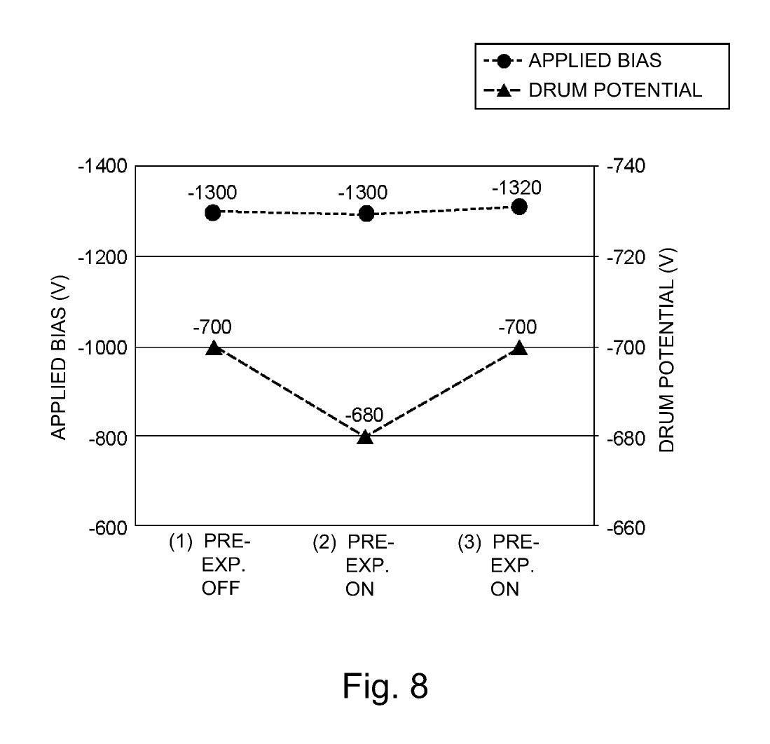

FIG. 8 shows a relationship between an “applied charging bias” to the charging roller 2c (left ordinate) and a “charging potential on photosensitive drum (Vd)” at the developing position (position opposing 4c) of the photosensitive drum 1c (right ordinate) in the case of turning-on of the pre-exposure device 10a of the c image forming station and in the case of turning-off of the pre-exposure device 10a.

First, in the case where the pre-exposure device 10a is turned off in (1), the applied charging bias is −1300 V, whereas Vd is −700 V. Under the condition, in the case where the pre-exposure device 10a is turned on in (2), the applied charging bias was −1300 V, whereas the potential of the photosensitive drum 1c at the developing position was −680 V.

The reason why a difference (20 V) generates between the potentials of this photosensitive drum 1c is that there is a difference in dark-decay characteristic between the case where the pre-exposure device 10a is turned off and the case where the pre-exposure device 10a is turned off. This dark-decay characteristic is, as described above, a phenomenon that after the photosensitive member is charged to a desired potential by the charging device, the potential of the photosensitive member naturally lowers will be lapse of time.

In the case where the pre-exposure device 10c is turned on, the potential of the photosensitive drum 1c is optically discharged to the neighborhood of 0 V, and therefore, in the photosensitive drum 1c, a photo-carrier tends to generates in a larger amount than during the light irradiation by the exposure device 3c for effecting the image exposure. In the case where the light irradiation is effected by the exposure device 3c, this photo-carrier flows from the electroconductive substrate of the photosensitive drum 1c toward the earth (grounding), but in the case where the light irradiation is effected by the pre-exposure device 10a, the photo-carrier remains in the photosensitive drum 1a although an amount thereof is slight.

Therefore, in the case where the pre-exposure device 10a is turned on, compared with the case where the pre-exposure device 10a is turned off, by a residual photo-carrier in the photosensitive drum 1c, the dark-decay phenomenon until the charged portion reaches the developing position (position opposing 4c) becomes large. That is, in the case where the pre-exposure device 10a is turned on, compared with the case where the pre-exposure device 10a is turned off, the charge potential of the photosensitive drum 1c lower in larger degree (absolute value). As a result, in the case where the pre-exposure device 10a is turned on, compared with the case where the pre-exposure device 10a is turned off, there is a liability that the toner image density becomes dense unintendedly.

Therefore, in this embodiment, such an unintended fluctuation of the image density is corrected. That is, as shown in (3) of FIG. 8, the applied charging bias may preferably be switched from −1300 V to −1320 V. In other words, the applied charging bias applied to the charging device 2c in the case where the pre-exposure device 10a is turned on is switched so as to be larger in absolute value than that in the case where the pre-exposure device 10a is turned off.

Incidentally, in the above, the C image forming station was specifically described, but also with regard to the Bk image forming station including the pre-exposure device 10b, the applied charging bias applied to the charging device 2d may preferably be switched similarly.

Thus, in order to correct the above-described density fluctuation, in this embodiment, the following control was employed specifically.

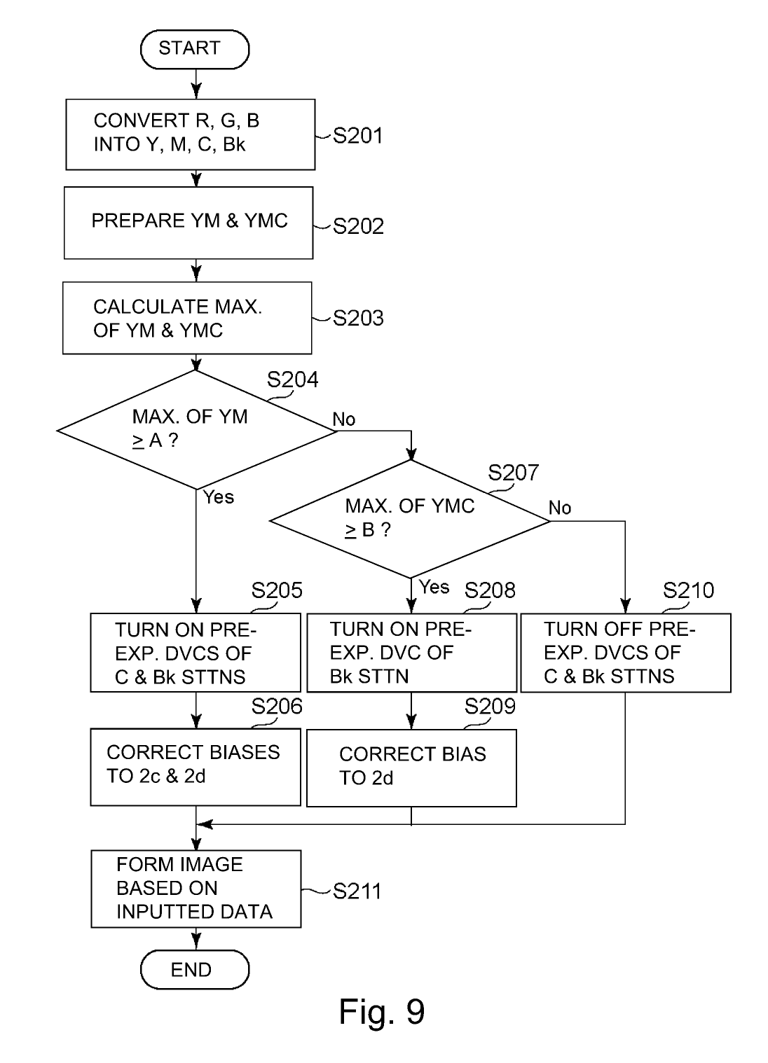

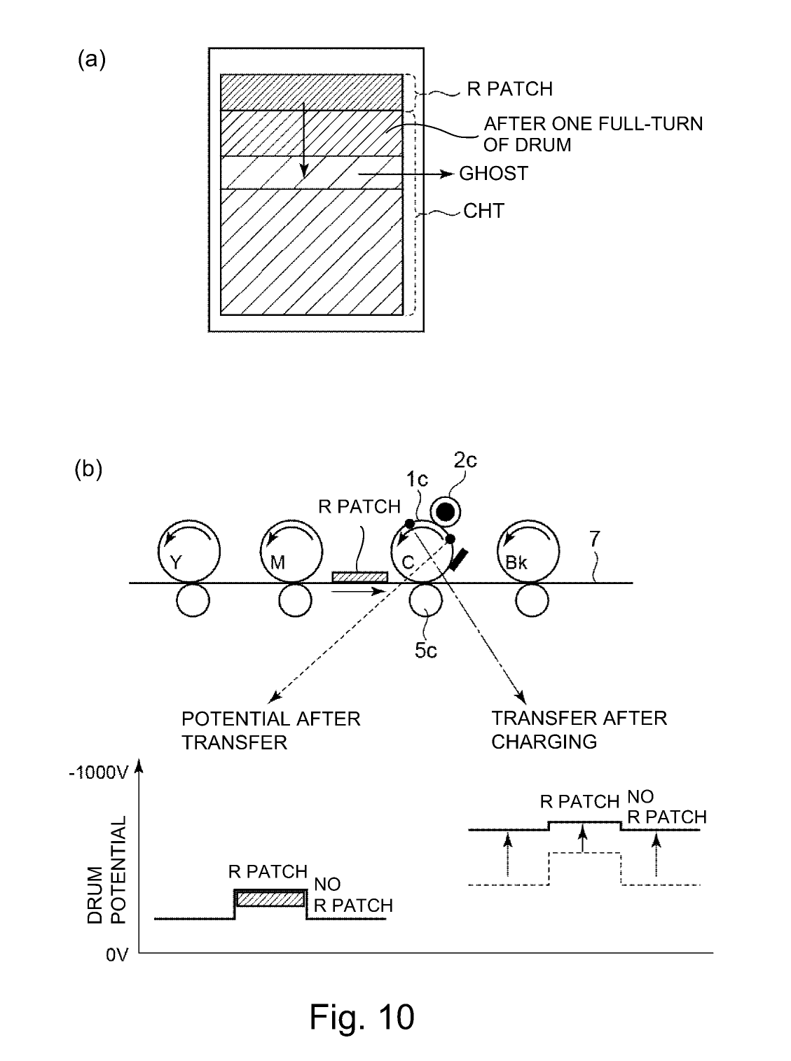

FIG. 9 is an operation flow.

In the image forming apparatus of FIG. 5, when image formation is started, inputted image data (image data of R, G and B) are converted into image data of Y, M, C and Bk in an image data converting portion in the controller 100 (S201).

Of the converted image data, image data YM obtained by synthesizing the Y and M image data and image data YMC obtained by synthesizing the Y, M and C image data are prepared by the controller 100 (S202).

Next, amount values of the image data YM and the image data YMC are calculated by the controller 100 (S203).

Next, whether the maximum value of the image data YM is not less than the predetermined value A is discriminated by the controller 100 (S204). Thus, the discrimination is made using the image data in the two image forming stations (Y, M) in the upstream side.

Thereafter, as described above, the applied bias to the charging rollers 2c and 2d is corrected. In this embodiment, the applied bias was changed from −1300 V to −1320 V (S206).

In S204, when the maximum amount is less than the predetermined amount A, whether or not the maximum amount of the image data YMC is not less than the predetermined value B is discriminated (S207).

When the maximum amount is not less than the predetermined amount B, the pre-exposure device 20b of the Bk image forming station positioned downstream of Y, M and C image forming stations is turned on (S208).

Thereafter, as described above, the applied bias to the charging roller 2d is corrected. In this embodiment, the applied bias was corrected from −1300 V to −1320 V (S209).

In S207, when the maximum amount is less than the predetermined amount B, the pre-exposure devices 10a and 10b of the C and Bk image forming stations are set to be turned off (S210).

After the on/off discriminations of the pre-exposure devices and the applied charging bias correcting step in S206, S209 and S210, on the basis of the inputted image data, the respective color images are formed at the respective image forming stations (S211). Incidentally, a light irradiation condition for the pre-exposure device was, similarly as in Embodiment 1, 630 nm in peak wavelength and 130 μW in light quantity. Further, the light irradiation by the pre-exposure device was effected in periods of the printing step c. and the sheet interval step d. in FIG. 3.

Thus, in this embodiment, in addition to the advantage of the constitution of Embodiment 2, it becomes possible to suppress the fluctuation in image density in the case where the pre-exposure device is turned on.

In the above, the image forming apparatuses according to the present invention were described in Embodiments 1 to 3, but the present invention is not limited to such embodiments, and within the scope of ideas of the present invention, various constitutions can be replaced with other constitutions.

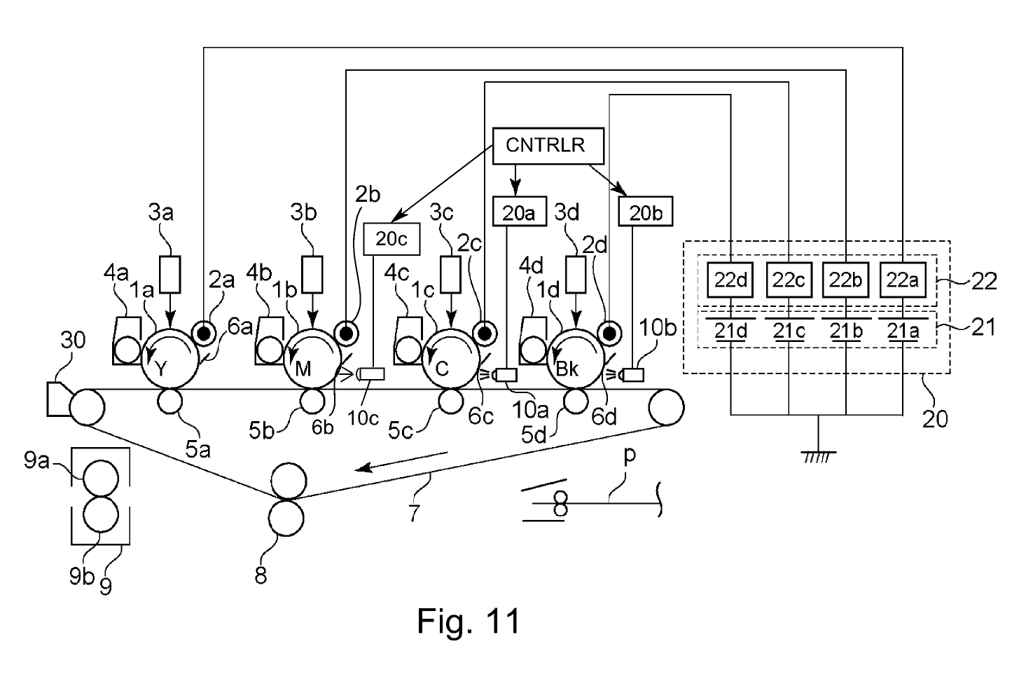

For example, in Embodiments 1 to 3, of the four image forming stations of Y, M, C and Bk, the constitution in which only the image forming stations of C and Bk are provided with the pre-exposure device was employed, but the present invention is not limited to such an exposure means. That is, as shown in FIG. 11, a constitution in which only the image forming stations of M, C and Bk excluding the most upstream image forming station from the four image forming stations of Y, M, C and Bk may also be employed. In this case, in the case where there is a liability that the amount of the Y toner coming to the transfer position of the second image forming station of M is large and the ghost phenomenon generates in the image forming station of M similarly as in Embodiments 1 to 3, the above constitution is effective.

Further, in Embodiments 1 to 3, the example in which there are four (Y, M, C, Bk) image forming stations was described, but for example, the present invention is also similarly applicable to even an embodiment in which there are three (Y, M, C) image forming stations or an embodiment in which there are five or more image forming stations.

Further, in the case of the embodiment in which there are three image forming stations Y, M and C, similarly as in the above-described Embodiments 2 to 3, on the basis of the Y image data and the M image data, ON/OFF of the pre-exposure device of the C image forming station may preferably be controlled.

Further, in the case of the embodiment in which there are five or more image forming stations, similarly as in the above-described Embodiments 2 to 3, ON/OFF control of the pre-exposure device in the associated image forming station may preferably be effected on the basis of the image data in the image forming station positioned upstream of the associated image forming station with respect to the movement direction of the intermediary transfer belt 7.

Further, in Embodiment 3, in order to suppress the image density fluctuation due to the ON/OFF of the pre-exposure device, the applied charging bias applied to the charging device is corrected (adjusted), but instead thereof, the light-portion potential (VL) may also be changed by correcting (adjusting) light irradiation intensity by the exposure device. However, a potential lowering (absolute value) generates with respect to the dark-portion potential (Vd) on the photosensitive drum, and therefore as in Embodiment 3, it is further preferable that the applied charging bias is adjusted.

Further, in Embodiments 1 to 3, the pre-exposure device employed the LEDs arranged in the longitudinal direction of the photosensitive drums, but may also employ LEDs having another constitution. For example, a constitution in which LEDs are provided in both end sides one by one with respect to the rotational axis direction (longitudinal direction) and lights from these LEDs are used for light irradiation of the photosensitive drums substantially in the entire area with respect to the rotational axis direction of the photosensitive drums through light guiding members (light guides) may also be employed.

Further, in Embodiments 2 to 3, the photosensitive drum was subjected to the ON/OFF control, but instead thereof, although the photosensitive drum is turned on in either case, the light irradiation amount (light quantity) may also be switched between the case there the light irradiation amount is increased and the case where the light irradiation amount is made smaller than that in the case of the increase. However, this constitutes a factor of deterioration promotion of the photosensitive members, and therefore the above-described Embodiments 2 to 3 are more preferable.

Further, in Embodiments 1 to 3, as the pre-exposure device, the LEDs are employed, but the pre-exposure device is not limited thereto, and may also be another irradiation means such as a lamp.

Further, in Embodiments 1 to 3, the constitution in which the charging roller which is the charging device is disposed in contact with the photosensitive member surface is employed, but the present invention is not limited thereto, and a constitution in which the charging roller is disposed near to the photosensitive member surface through a small gap may also be employed.

### INDUSTRIAL APPLICABILITY

According to the present invention, there is provided an image forming apparatus capable of suppressing generation of image defect while reducing costs.

1. An image forming apparatus comprising:
a first image forming station including a first photosensitive member, charging means configured to charge said first photosensitive member, first exposure means configured to expose said first photosensitive member charged by said first charging means to light on the basis of first image data, and first developing means configured to develop with a toner an electrostatic latent image formed on said first photosensitive member by said first exposure means;
a second image forming station including a second photosensitive member, second charging means configured to charge said second photosensitive member by being supplied with only a DC voltage, second exposure means configured to expose said second photosensitive member charged by said second charging means to light on the basis of second image data, and second developing means configured to develop with a toner an electrostatic latent image formed on said second photosensitive member by said second exposure means; and
transfer means configured to electrostatically transfer superposedly a toner image formed on said first photosensitive member and a toner image formed on said second photosensitive member onto an image receiving member in this order,
wherein said first image forming station is not provided with discharging means configured to optically discharge said first photosensitive member, and said second image forming station is provided with discharging means configured to optically discharge said second photosensitive member.

2. An image forming apparatus according to claim 1, comprising control means configured to control an operation of said discharging means depending on the first image data.

3. An image forming apparatus according to claim 2, wherein said control means actuates said discharging means when a toner amount corresponding to the first image data is not less than a predetermined amount and does not actuate said discharging means when the toner amount corresponding to the first image data is less than the predetermined amount.

4. An image forming apparatus according to claim 1, wherein said transfer means includes a first transfer member disposed opposed to said first photosensitive member via the image receiving member and configured to electrostatically transfer the toner image formed on said first photosensitive member onto the image receiving member and a second transfer member disposed opposed to said second photosensitive member via the image receiving member and configured to electrostatically transfer the toner image formed on said second photosensitive member onto the image receiving member, and wherein to said first transfer member and said second transfer member, in a corresponding transfer step, a voltage of an opposite polarity to a normal charge polarity of a toner is applied.

5. An image forming apparatus according to claim 4, comprising a transfer mechanism configured to electrostatically transfer the toner image transferred on the image receiving member onto a recording material.

6. An image forming apparatus according to claim 1, wherein said discharging means discharges said second photosensitive member at a position downstream of a transfer position by said transfer means and upstream of a charging position by said second charging means with respect to a movement direction of said second photosensitive member.

7. An image forming apparatus comprising:
a first image forming station including a first photosensitive member, first charging means configured to charge said first photosensitive member, first exposure means configured to expose said first photosensitive member charged by said first charging means to light on the basis of first image data, and first developing means configured to develop with a toner an electrostatic latent image formed on said first photosensitive member by said first exposure means;
a second image forming station including a second photosensitive member, second charging means configured to charge said second photosensitive member, second exposure means configured to expose said second photosensitive member charged by said second charging means to light on the basis of second image data, and second developing means configured to develop with a toner an electrostatic latent image formed on said second photosensitive member by said second exposure means;
a third image forming station including a third photosensitive member, third charging means configured to charge said third photosensitive member by being supplied with only a DC voltage, third exposure means configured to expose said third photosensitive member charged by said third charging means to light on the basis of third image data, and third developing means configured to develop with a toner an electrostatic latent image formed on said third photosensitive member by said third exposure means;
a fourth image forming station including a fourth photosensitive member, fourth charging means configured to charge said fourth photosensitive member by being supplied with only a DC voltage, fourth exposure means configured to expose said fourth photosensitive member charged by said fourth charging means to light on the basis of fourth image data, and fourth developing means configured to develop with a toner an electrostatic latent image formed on said fourth photosensitive member by said fourth exposure means; and
transfer means configured to electrostatically transfer superposedly a toner image formed on said first photosensitive member, a toner image formed on said second photosensitive member, a toner image formed on said second photosensitive member, and a toner image formed on said fourth photosensitive member onto an image receiving member in this order,
wherein said first image forming station and said second image forming station are not provided with discharging means, respectively, configured to optically discharge corresponding ones of said photosensitive members, and said third image forming station and said fourth image forming station are provided with discharging means, respectively, configured to optically discharge corresponding ones of said photosensitive members.

8. An image forming apparatus according to claim 7, comprising control means configured to control an operation of said discharging means of said third image forming station depending on the first image data and the second image data.

9. An image forming apparatus according to claim 8, wherein said control means actuates said discharging means of said third image forming station when a sum of a toner amount corresponding to the first image data and a toner amount corresponding to the second image data is not less than a predetermined amount and does not actuate said discharging means of said third image forming station when the sum is less than the predetermined amount.

10. An image forming apparatus according to claim 7, comprising control means configured to control an operation of said discharging means of said fourth image forming station depending on the first image data, the second image data and the third image data.

11. An image forming apparatus according to claim 10, wherein said control means actuates said discharging means of said fourth image forming station when a sum of a toner amount corresponding to the first image data, a toner amount corresponding to the second image data and a toner amount corresponding to the third image data is not less than a predetermined amount and does not actuate said discharging means of said fourth image forming station when the sum is less than the predetermined amount.

12. An image forming apparatus according to claim 7, wherein said transfer means includes a first transfer member disposed opposed to said first photosensitive member via the image receiving member and configured to electrostatically transfer the toner image formed on said first photosensitive member onto the image receiving member, a second transfer member disposed opposed to said second photosensitive member via the image receiving member and configured to electrostatically transfer the toner image formed on said second photosensitive member onto the image receiving member, a third transfer member disposed opposed to said third photosensitive member via the image receiving member and configured to electrostatically transfer the toner image formed on said third photosensitive member onto the image receiving member, and a fourth transfer member disposed opposed to said fourth photosensitive member via the image receiving member and configured to electrostatically transfer the toner image formed on said fourth photosensitive member onto the image receiving member, and wherein to said first transfer member, said second transfer member, said third transfer member and said fourth transfer member, in a corresponding transfer step, a voltage of an opposite polarity to a normal charge polarity of a toner is applied.

13. An image forming apparatus according to claim 12, comprising a transfer mechanism configured to electrostatically transfer the toner image transferred on the image receiving member onto a recording material.

14. An image forming apparatus according to claim 7, wherein each of said discharging means discharges a corresponding one of said photosensitive members at a position downstream of a transfer position by said transfer means and upstream of a charging position by a corresponding one of said charging means with respect to a movement direction of a corresponding one of said photosensitive members.

15. An image forming apparatus comprising:
a first image forming station including a first photosensitive member, first charging means configured to charge said first photosensitive member, first exposure means configured to expose said first photosensitive member charged by said first charging means to light on the basis of first image data, and first developing means configured to develop with a toner an electrostatic latent image formed on said first photosensitive member by said first exposure means;
a second image forming station including a second photosensitive member, second charging means configured to charge said second photosensitive member by being supplied with only a DC voltage, second exposure means configured to expose said second photosensitive member charged by said second charging means to light on the basis of second image data, and second developing means configured to develop with a toner an electrostatic latent image formed on said second photosensitive member by said second exposure means;
a third image forming station including a third photosensitive member, third charging means configured to charge said third photosensitive member by being supplied with only a DC voltage, third exposure means configured to expose said third photosensitive member charged by said third charging means to light on the basis of third image data, and third developing means configured to develop with a toner an electrostatic latent image formed on said third photosensitive member by said third exposure means;
a fourth image forming station including a fourth photosensitive member, fourth charging means configured to charge said fourth photosensitive member by being supplied with only a DC voltage, fourth exposure means configured to expose said fourth photosensitive member charged by said fourth charging means to light on the basis of fourth image data, and fourth developing means configured to develop with a toner an electrostatic latent image formed on said fourth photosensitive member by said fourth exposure means; and
transfer means configured to electrostatically transfer superposedly a toner image formed on said first photosensitive member, a toner image formed on said second photosensitive member, a toner image formed on said third photosensitive member, and a toner image formed on said fourth photosensitive member onto an image receiving member in this order,
wherein said first image forming station is not provided with discharging means configured to optically discharge said photosensitive member, and said second image forming station, said third image forming station and said fourth image forming station are provided with discharging means, respectively, configured to optically discharge corresponding ones of said photosensitive member.

16. An image forming apparatus according to claim 15, comprising control means configured to control an operation of said discharging means of said second image forming station depending on the first image data.

17. An image forming apparatus according to claim 16, wherein said control means actuates said discharging means of said second image forming station when a toner amount corresponding to the first image data is not less than a predetermined amount and does not actuate said discharging means of said second image forming station when the toner amount corresponding to the first image data is less than the predetermined amount.

18. An image forming apparatus according to claim 15, comprising control means configured to control an operation of said discharging means of said third image forming station depending on the first image data and the second image data.

19. An image forming apparatus according to claim 18, wherein said control means actuates said discharging means of said third image forming station when a sum of a toner amount corresponding to the first image data and a toner amount corresponding to the second image data is not less than a predetermined amount and does not actuate said discharging means of said third image forming station when the sum is less than the predetermined amount.

20. An image forming apparatus according to claim 15, comprising control means configured to control an operation of said discharging means of said fourth image forming station depending on the first image data, the second image data and the third image data.

21. An image forming apparatus according to claim 20, wherein said control means actuates said discharging means of said fourth image forming station when a sum of a toner amount corresponding to the first image data, a toner amount corresponding to the second image data and a toner amount corresponding to the third image data is not less than a predetermined amount and does not actuate said discharging means of said fourth image forming station when the sum is less than the predetermined amount.

22. An image forming apparatus according to claim 15, wherein said transfer means includes a first transfer member disposed opposed to said first photosensitive member via the image receiving member and configured to electrostatically transfer the toner image formed on said first photosensitive member onto the image receiving member, a second transfer member disposed opposed to said second photosensitive member via the image receiving member and configured to electrostatically transfer the toner image formed on said second photosensitive member onto the image receiving member, a third transfer member disposed opposed to said third photosensitive member via the image receiving member and configured to electrostatically transfer the toner image formed on said third photosensitive member onto the image receiving member, and a fourth transfer member disposed opposed to said fourth photosensitive member via the image receiving member and configured to electrostatically transfer the toner image formed on said fourth photosensitive member onto the image receiving member, and wherein to said first transfer member, said second transfer member, said third transfer member and said fourth transfer member, in a corresponding transfer step, a voltage of an opposite polarity to a normal charge polarity of a toner is applied.

23. An image forming apparatus according to claim 22, comprising a transfer mechanism configured to electrostatically transfer the toner image transferred on the image receiving member onto a recording material.

24. An image forming apparatus according to claim 15, wherein each of said discharging means discharges a corresponding one of said photosensitive members at a position downstream of a transfer position by said transfer means and upstream of a charging position by a corresponding one of said charging means with respect to a movement direction of a corresponding one of said photosensitive members.
